(19) United States
(12) Patent Application Publication
(10) Pub. No.: US 2008/0028359 A1
(43) Pub. Date: Jan. 31, 2008

(54) Termination structure, a mask for manufacturing a termination structure, a lithographic process and a semiconductor device with a termination structure

(76) Inventors: Stefan Blawid, Dresden (DE); Wolfram Koestler, Langebrueck (DE); Ralf Ziebold, Radebeul (DE)

Correspondence Address: SLATER & MATSIL LLP, 17950 PRESTON ROAD, SUITE 1000, DALLAS, TX, 75252, US

(21) Appl. No.: 11/496,279

(22) Filed: Jul. 31, 2006

(51) Int. Cl. G06F 17/50

(52) U.S. Cl. 716/21

(57) ABSTRACT

Termination structure for a pattern, especially an at least partially regular spaced pattern used in the manufacturing of semiconductor devices, especially DRAM-chips, wherein the termination structure comprises at least a first line-shaped element and at least one extension element adjacent to the first line-shaped element partially increasing the width of the first line-shaped element.

### TECHNICAL FIELD

The present invention relates generally to semiconductor devices and in particular embodiments to a termination structure, a mask for manufacturing a termination structure, a lithographic process and a semiconductor device with a termination structure.

### BACKGROUND

This invention relates generally to a structure used in the manufacturing of a semiconductor device. Examples for semiconductor devices as meant in the context of this invention are DRAM-chips, NROM-chips, microprocessors and intermediate products that are manufactured during the process of producing an end product. An example of an intermediate product is, e.g., a structured silicon wafer as substrate that is then further processed.

In the manufacturing processes for semiconductor devices, structures are generally transferred to a substrate using lithographic methods, even though the current invention is not limited to lithographic methods.

The structures on the substrate often comprise patterns, especially regular patterns, such as regular line-space-patterns. Those line-space-patterns are, e.g., used for building dense memory cell arrays, support devices such as wordlines drivers or sense amplifiers.

Those patterns, especially regular patterns are terminated by termination structures such as semi-isolated line-shaped structures. In the context of this invention, line-shaped structures can be defined as structures at least three times longer than their width.

At one side semi-isolated line shapes are adjacent to densely placed structures with a high density characteristic to the semiconductor device under consideration. At the opposing side no other structures are placed for a distance noticeably larger than the one to the dense structures. In general, the boundary line-shaped structure divides areas of different structure densities.

Those termination structures have the problem that they are often mechanically unstable, e.g., under rinsing condition. This instability can result in the collapse of the bounding structure. The remains of a collapsed termination structure might cause short circuits.

### SUMMARY OF THE INVENTION

In a first aspect of the invention refers to a termination structure for a pattern, especially an at least partially regular spaced pattern in the manufacturing of semiconductor devices, especially DRAM-chips, wherein the termination structure comprises at least a first line-shaped element and at least one extension element adjacent to the first line-shaped element partially increasing the width of the first line-shaped element.

Furthermore, the invention refers to a termination structure for a pattern, especially an at least partially regular spaced pattern used in the manufacturing of semiconductor devices, especially DRAM-chips, wherein the termination means comprises at least a first line-shaped element and at least one extension means adjacent to the first line-shaped element partially increasing the width of the first line-shaped element.

Another aspect of the invention is a mask for manufacturing a termination structure and a lithographic process for manufacturing a termination structure.

### BRIEF DESCRIPTION OF THE DRAWINGS

Embodiments and advantages of the invention become apparent upon reading of the detailed description of the invention, and the appended claims provided below, and upon reference to the drawings.

FIG. 1 shows schematically a regular pattern and a termination structure on a mask according to the prior art;

FIGS. 2A-2C, collectively FIG. 2, show schematically three embodiments of a termination structure on a mask according to the invention with rectangular extension elements on one side;

FIG. 3 shows schematically an embodiment of the termination structure on a mask according to the invention with rectangular extension elements on both sides;

FIG. 4 shows schematically an embodiment of a termination structure with extension elements between two line-shaped elements;

FIG. 5 shows schematically another embodiment of a termination structure with subresolution assists;

FIG. 6 shows a drawing taken from an SEM image showing the structure of FIG. 5 on a substrate after a lithographic process;

FIGS. 7A-7D, collectively FIG. 7, show simulated widths of a photo resist profile when imaging a termination structure according to FIG. 5 via a lithographic process;

FIG. 8 shows another embodiment of the termination structures aligned with a trench structure;

FIGS. 9A-9D schematically show another embodiment of a termination structure. Depicted are also some neighboring structures on the opposite side to the dense regular line-space pattern;

FIGS. 10A-10C show three regular patterns in connection with embodiments of termination structures; and

FIGS. 11A-11D show four embodiments of shapes for extension elements.

### DETAILED DESCRIPTION OF ILLUSTRATIVE EMBODIMENTS

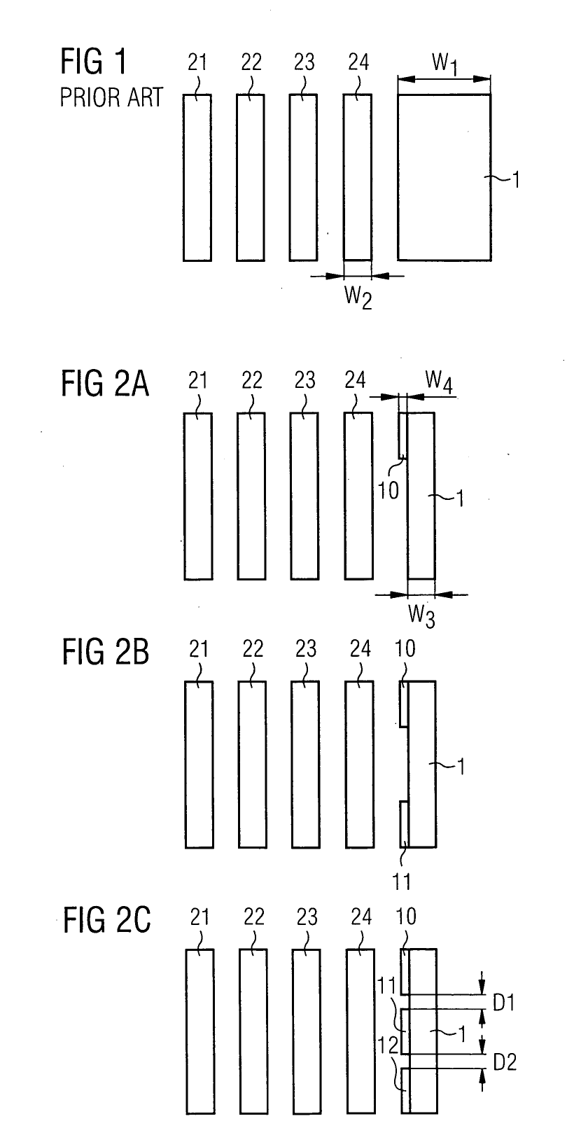

FIG. 1 schematically depicts a section of a structure on a mask used for manufacturing a semiconductor device, such as a DRAM-chip, an NROM-chip or microprocessors in general. The view in FIG. 1 (and in FIGS. 2 to 6) is a top view.

In the following figures the line-shaped elements depicted are generally intransparent or transparent patterns on a mask that translate into resist patterns on a substrate, the resist pattern having the corresponding shape of the mask pattern. The resist pattern is then transferred using normal etching processes. The same patterns, though on a different scale, are to be found on the substrate after the lithographic processing with the mask. The invention covers termination structures on a mask as well as termination structures on a substrate produced, e.g., by lithographic processes. If not specifically indicated, the following figures can be taken as representatives of termination structures either on a mask or a substrate.

Equivalent structures can be found on intermediate products. Therefore, all figures in the following apply to devices, products and masks used in the production of such devices.

In FIG. 1 a regular pattern 21, 22, 23, 24 is positioned next to a termination structure 1 as it is known. The termination structure 1 is a semi-isolated line with a width of W₁, also referred to as a termination line.

The regular pattern 21, 22, 23, 24 comprises four lines and is considered to be a part of a regular line-spaced pattern. The termination structure is placed at a distance to the regular pattern 21, 22, 23, 24 comparable to the spaces within the pattern. The space to possible neighboring structures to the right (not depicted here) is noticeably larger.

A person skilled in the art will recognize that FIGS. 1 to 6 are highly schematical to highlight the principle of the prior art (FIG. 1) and the invention (FIGS. 2 to 6). The real regular pattern and the termination structure might have different relative dimensions. Due to manufacturing constraints some lines and edges might not be as sharply defined as depicted.

In the prior art, the termination structure 1 comprises a line-shaped element with a larger width W₁ than the width W₂ of the regular pattern 21, 22, 23, 24. In this context, line-shaped means that the shape of the structure is essentially at least three times longer than its width. The line-shaped element might comprise more than one segment, to allow complex shapes.

As will be depicted later, the structures on the mask are, e.g., transferred into three dimensional ridges on a substrate.

Terminating line-shaped structures show increased process induced width variations compared to regular pattern. Therefore, termination structures generally are not part of an electrically functional device. However, the termination structure may affect the adjacent device. Directly by bridging or collapsing into the dense device-forming-elements, indirectly by causing shorts, leakage currents and parasitic capacities when interacting with other device building layers.

In FIGS. 2 to 6 different embodiments of the invention are described.

A mechanical stable termination structure 1 according to the embodiment depicted in FIG. 2A comprises a first line-shaped element 1 with a width W₃ and with one extension element 10 with a width W₄ adjacent to it. The extension element 10 is adjacent the first line-shaped element 1 and provides mechanical support to it. In the context of a termination structure on a mask, an adjacent extension element 10 means that there might be a small free space between the first line-shaped element 1 and the extension element 10, the small free space being too small to print on a substrate after transferring the mask pattern to a substrate. In a substrate the extension element 10 will be generally adjacent and coupled to the first line-shaped element 1. In the figures the adjacent extension element 10 is depicted as being coupled to the first line-shaped element 1. A person skilled in the art will recognize that a small free space might be present particularly on the mask.

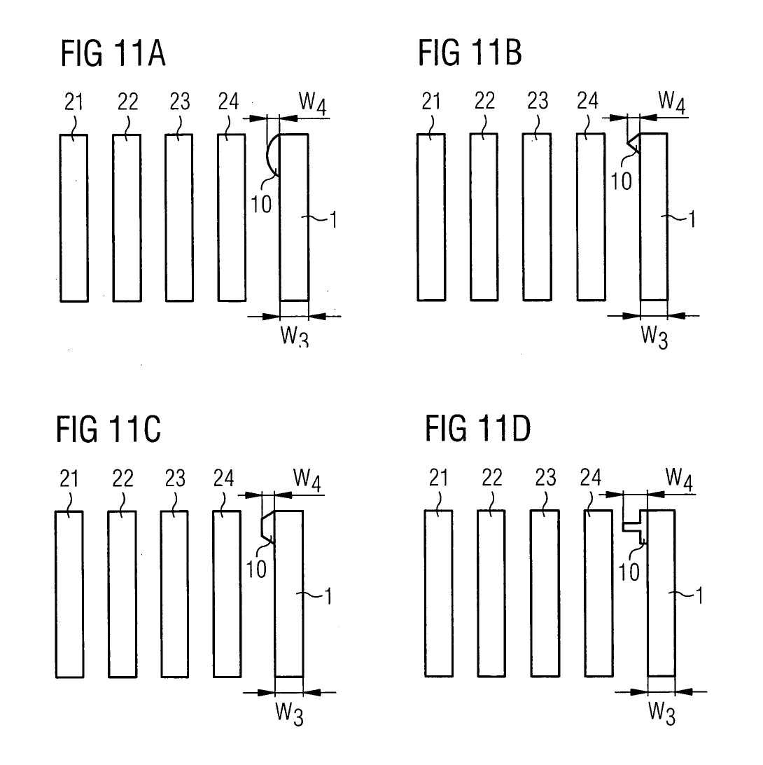

The width of the terminating line-shaped element is comparable to the size of the regular pattern 21, 22, 23, and 24. The extension element 10 increases the width of the termination structure by a few percent (e.g., 5%) up to tripling the width. The shape of the extension element 10 is here rectangular. Alternatively, the extension element 10 can be shaped like a polygon, a semicircle, a triangle or a T-shaped element. In all cases the width is increased. In FIGS. 11A to 11D such shapes are depicted. The structures in FIG. 11A to 11D are basically the same as in FIG. 2A so that the relevant description is applicable.

A line-shaped element 1 is understood to have, e.g., a length that is at least three times as long as its width. The line-shaped elements 1 depicted here are essentially rectangularly shaped.

After a processing step using a mask as described above, a regular pattern 21, 22, 23, 24 and the termination structure (first line-shaped element 1 and extension element 10) are produced on a substrate. A rinsing process step puts mechanical stress on the termination structure on the substrate due to capillary forces. The support provided by the extension element 10 prevents a damage to the termination structure. But the width W₃ of the first line-shaped element 1 in the termination structure is smaller than the width W₁ of the termination structure in the prior art (FIG. 1). The extension element 10 provides a partial width extension (width modulation) to the first line-shaped element 1. This stabilizes the termination structure without making it unduly wide.

In FIGS. 2B to 4 different embodiments are described that perform width extensions to a first line-shaped element 1 in various forms. One issue is always stabilization of the termination structure 1 next to a regular pattern. For the sake of clarity the labeling of the widths of the elements is not repeated in FIGS. 2B to 4.

In FIGS. 2B and 2C, two and three, respectively, extension elements 10, 11, 12 are positioned to one side of the first line-shaped element 1. In FIG. 2C the distances D₁ and D₂ between the extension elements 10, 11, 12 are shown. In principle the number of extension elements 10, 11, 12 can be much higher than three and the distances D₁, D₂ can be equal or unequal. Taking this into account, periodic patterns of the extension elements 10, 11, 12 along the line-shaped element 1 can be realized.

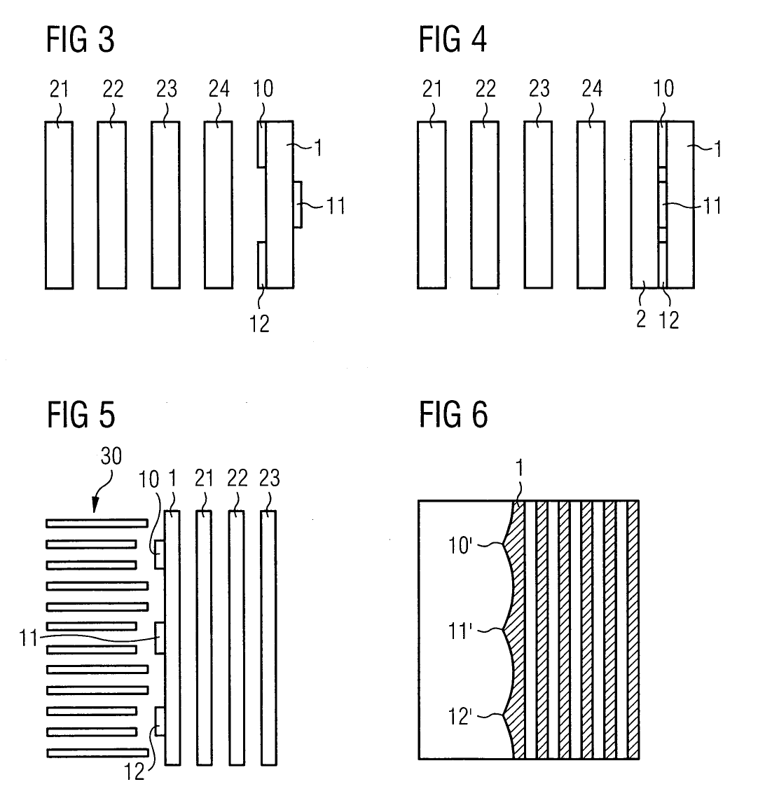

In FIG. 3 an embodiment is shown in which the termination structure next to the regular line pattern 21, 22, 23, 24 has extension elements 10, 11, 12 on both sides of the first line-shaped element 1. The extension elements 10, 11, 12 extend the width on both sides, here in an alternating pattern, i.e., one extension element 10 on the left side is followed by one extension element 11 on the right side and so on.

In all embodiments depicted in FIG. 2 and FIG. 3 the extension elements 10, 11, 12 had an essential rectangular shape section.

In FIG. 4 a different embodiment for a termination structure is shown. As in the previous embodiments, a first line-shaped element 1 has extension elements 10, 11, 12 on one side. Here rectangular extension elements 10, 11, 12 are positioned on the left side of the first line-shaped element 1. Adjacent to the extension elements 10, 11, 12 on their left side is a second line-shaped element 2 that has a rectangular shaped section. The complete termination structure has in effect a ladder structure giving it an especially high mechanical stability.

The person skilled in the art will recognize that the ladder structure in FIG. 4 can be combined with structures depicted in FIGS. 2 and 3 so that more complex structures are within the scope of the invention.

In FIG. 5 a termination structure comprising a line-shaped element 1 and three extension elements 10, 11, 12 on its left side is depicted on a mask. The extension elements 10, 11, 12 are facing away from the regular pattern with line elements 21, 22, 23 on the right side. Otherwise the structure is the same as, e.g., shown in FIG. 2C.

To the left of the termination structure subresolution assist features (SRAF) 30 are positioned (aligned) which are used to support the extension elements 10, 11, 12. The subresolution structures help in optically stabilizing the at least one extension elements 10, 11, 12.

Extensions (or synonymic width modulations) placed at the opposite side of the regular pattern have the advantage that SRAFs can be employed to increase focus stability during lithographic imaging. Zebra like assist features (like the one depicted in FIG. 5) are especially well suited to support the width modulated terminating line because they can be adopted to the modulation as shown in FIG. 5.

In FIG. 6 a drawing made from an SEM image is showing the result of the printing on a substrate of the structure depicted schematically in FIG. 5. The three extension elements 10, 11, 12 result in three protrusions 10′, 11′, 12′ enlarging the width of a line-shaped element 1. To the right of the termination structure a regular pattern 21, 22, 23, 24 is shown. The termination structure on the substrate falls also in the scope of the present invention, even though the examples depicted are shown in the context of a lithography mask.

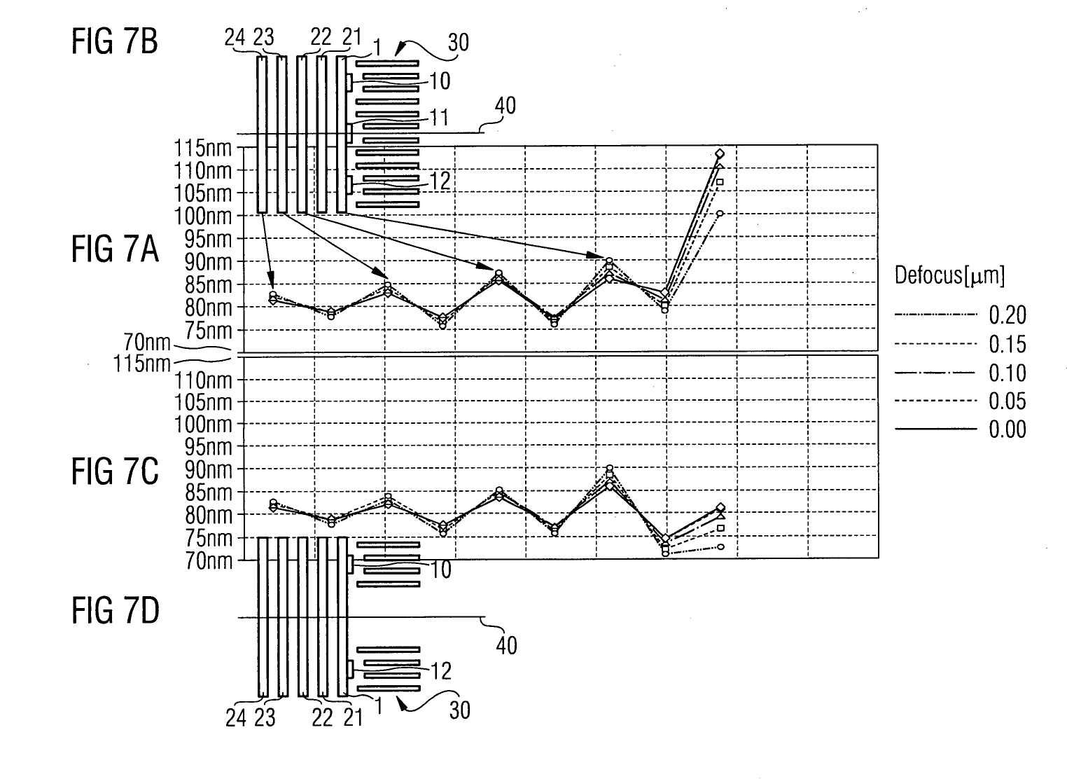

In FIGS. 7A and 7D a simulated photo resist pattern (corresponding to the SEM image depicted in FIG. 6) is shown after lithographically imaging the mask depicted in FIG. 7. FIG. 7B shows the critical dimension (CD) along a line 40 intersecting a regular line pattern 21, 22, 23, 24 (here wordlines) and the termination structure to the right to the regular line pattern 21, 22, 23, 24. The terminating structure has three extension elements 10, 11, 12. The simulation line 40 intersects one of those extension elements 11.

In FIG. 7D basically the same simulation is performed but the simulation line 41 does not intersect one of the extension elements 10, 11, 12 of the terminating structures.

The graphs in FIG. 7A and 7C show for varying defocus values (0 to 0,2 μm) that the CD of the regular line pattern 21, 22, 23, 24 is not substantially affected by the extension elements 11, 12, 13. In FIG. 7A the presence of the extension element itself is visible but its effect does not affect the wordlines 21, 22, 23, 24.

The difference is less than 2 nm, which is in the order of the numerical accuracy of the simulation. This shows that the stabilizing effect of the extension elements 10, 11, 12 does not lead to a noticeable CD variation of the regular wordline pattern.

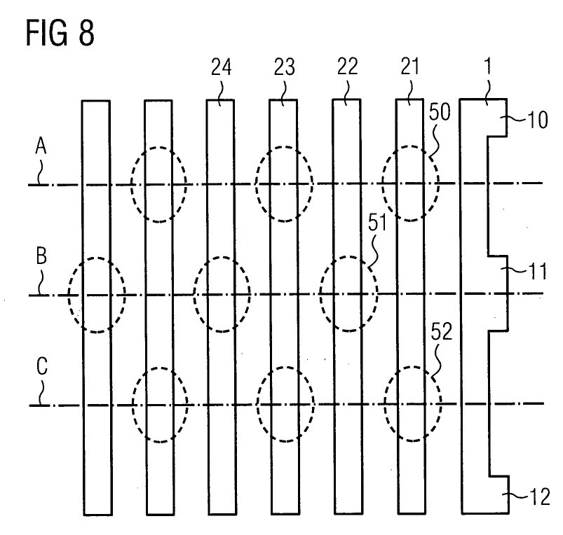

In FIG. 8 another embodiment of the termination structure is used in alignment with another structure.

The termination structure comprises a line-shaped element 1 with three extension elements 10, 11, 12 facing away from a regular line pattern 21, 22, 23, 24 comprising wordlines for a DRAM-chip. The wordlines 21, 22, 23, 24 are positioned over trench structures 50, 51, 52 in a generally known way. The position of the trench structures 50, 51, 52 is aligned with the extension elements 10, 11, 12. The exemplary first trench structure 50 is aligned along a line A so that it lies between two extension elements 10, 11. The second trench structure 51 is aligned along a line B so that it is aligned with an extension element 11. The third trench structure 52 is aligned along a line C lying between two extension elements 11, 12. As can be seen, the other trench structures in FIG. 8 are also aligned in the same pattern.

As previously shown in FIG. 7, the width modulation of the termination structure 1, 10, 11, 12 does not affect the lithography result.

Naturally the same principle can be applied to other regular patterns, for example, bitlines, wordlines, contact structures, isolating structures, active area structures or trench structures.

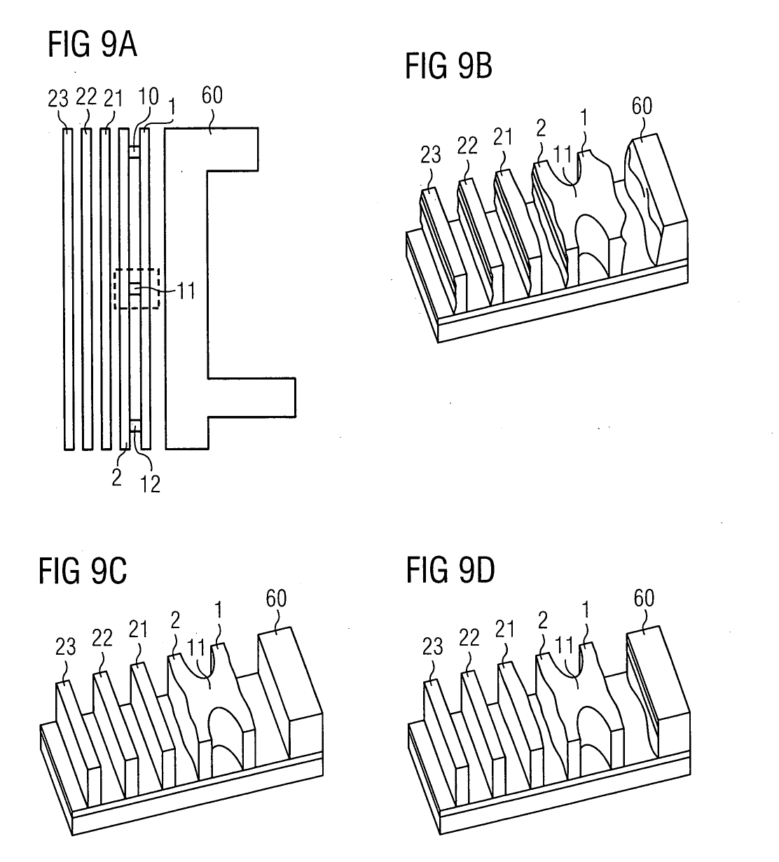

In FIGS. 9A to 9D a further embodiment is shown schematically. In FIG. 9A the termination structure for the regular line pattern 21, 22, 23 comprises a first line-shaped element 1 and three extension elements 10, 11, 12 facing towards the regular line pattern 21, 22, 23. To the right of the termination structure some arbitrary neighboring structure 60 is shown. This is an example of a semi-isolated structure. A semi-isolated structure has on one side relatively densely placed structures and on the other side relatively less densely placed structures.

Adjacent to the first line-shaped element 1, i.e., contacting with the extension elements 10, 11, 12 is a second line-shaped element 2, being a part of the regular line pattern (e.g., a wordline). The resulting termination structure comprises two line-shaped elements 1, 2 having different widths and between the two line-shaped elements three extension elements 10, 11, 12. The resulting termination structure is a ladder structure.

In FIGS. 9B to 9D a three dimensional view of a photo resist profile is shown resulting from a lithographic imaging of the mask depicted in FIG. 9A (cutout indicated by dashed frame). In FIG. 9B to 9D the ridge like linear line pattern 21, 22, 23 is positioned next to the termination structure 1, 2, 11. The termination structure comprises a first line-shaped element 1 and a second line-shaped element 2. In between the extension element 11, which is principally rectangular, prints after the lithography with smooth outlines into the line-shaped elements 1, 2. The extension element 11 extends the width of the first line-shaped element 1.

The difference between the lithographic results shown in FIG. 9B, 9C and 9D is the focus. FIG. 9C shows the best focus, the line-shaped elements 1, 2 having no prominent protrusions. A defocus of −0,2 μm (FIG. 9B) or +0,2 μm (FIG. 9D) results in somewhat larger protrusions.

FIGS. 9B to 9D show among other things the three-dimensional nature of the termination structure and the linear line patterns.

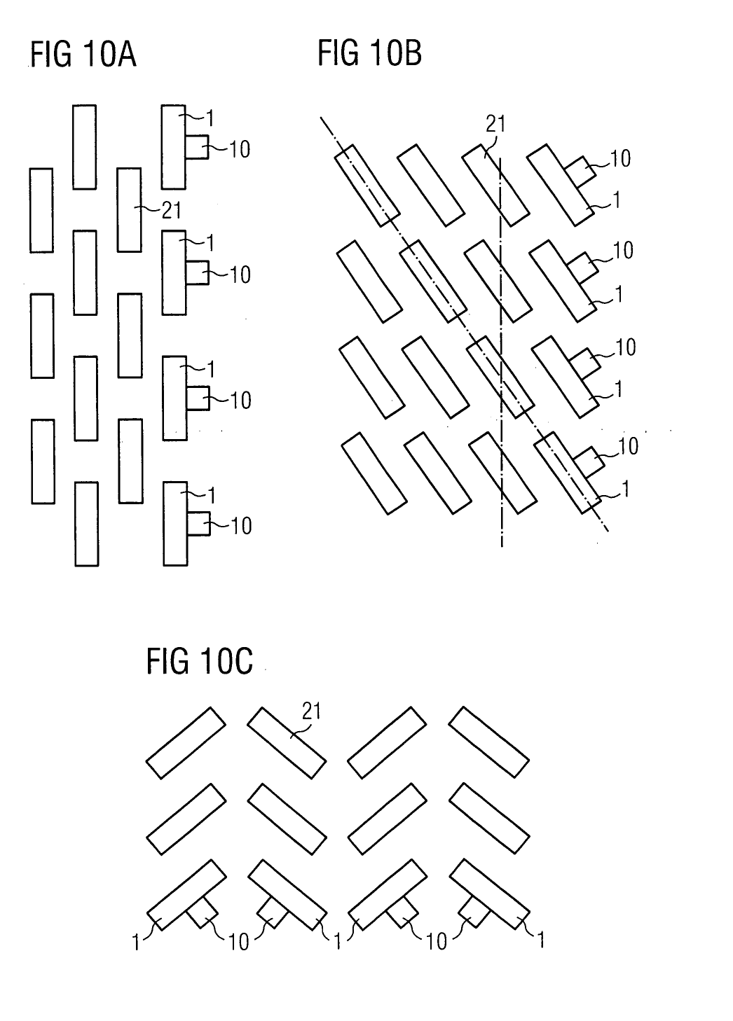

FIGS. 10A to 10C show three different applications for termination structures applied to two dimensional arrangements of line-shaped elements 1. In all three applications line-shaped elements 1 are depicted with one extension element 11 each. The extension element 11 faces away from the regular pattern 21 which is situated to the left of the termination structures 1 in FIGS. 10A and 10B and above the termination structures 1 in FIG. 10C. Naturally all extension elements 11 described above could be substituted for the embodiments shown in FIGS. 10A to 10B.

The regular pattern in each of FIGS. 10A to 10C is a regular structure showing, e.g., the contact pattern on a mask for a DRAM array. Alternatively, such a regular pattern could, e.g., be an active array.

In FIG. 10A the regular pattern comprises numerous line segments 21 that are parallel to each other and staggered, i.e., next to a gap between two line segments 21 two line segments 21 are positioned.

In FIG. 10B the regular pattern comprises numerous line segments 21 that are parallel to each other, and that are positioned in rows. The line segments 21 are slanted relative to neighboring structures not depicted here within each row. The slanting is such that line segments of neighboring row are falling on one line. Between the rows there is a gap. The line-shaped elements 1 of the termination structure are parallel to the line segments 21 of the pattern.

In FIG. 10C the regular pattern is similar to the one depicted in FIG. 10B, i.e., the line segments 21 are slanted. But the angle of the slant alternates between the columns, the line segments 21 in each column being parallel.

FIGS. 10A to 10C indicate that embodiments of termination structures can be used to terminate a wide range of possible regular patterns. The regularity in FIGS. 10A to 10C is only an example, the pattern itself can be at least partially irregular.

A person skilled in the art will recognize that the embodiments of FIGS. 2 to 10 are only exemplary. Especially the number and position of extension elements 10, 11, 12 in or at a termination structure is not limited to the embodiments shown here. Furthermore, the shape section of the extension elements 10, 11, 12 is assumed rectangular in the examples because this particular shape is relatively easy to manufacture. The printed result, i.e., the shape of the extension elements 10, 11, 12 after lithography might deviate somewhat from a strict rectangular shape smoothing out sharp corners. In principle, other shapes (see FIGS. 11A to 11D) are also possible for the extension elements 10, 11, 12 providing extension means for which the analog embodiments as shown in FIGS. 2 to 10 are possible, especially with respect to positions along the rectangular elements 1, 2 or the alignment.

Furthermore, the embodiments for the termination structure were mostly described in context with a lithography mask. It is apparent to a person skilled in the art that the same structures are also applicable to the result on a substrate after a lithographic process. FIGS. 2, 3, 4, 8, 9, 10, 11, e.g., depict the same structures that would be found on a substrate after a lithography process. The embodiments and their advantages would be applicable. The extension elements 10, 11, 12 in such a structure would, e.g., give additional stability in etching processes.

What is claimed is:

1. A termination structure for a pattern, especially an at least partially regular spaced pattern used in the manufacturing of semiconductor devices, especially DRAM-chips, wherein the termination structure comprises at least a first line-shaped element and at least one extension element adjacent to the first line-shaped element partially increasing the width of the first line-shaped element.

2. The termination structure according to claim 1, wherein the termination structure is positioned on at least one of the group of substrate, silicon wafer and lithography mask.

3. The termination structure according to claim 1, wherein in longest axis of the first line-shaped element is at least three times higher than the broadest width of the first line-shaped element.

4. The termination structure according to claim 3, wherein the fist line-shaped element comprises at least two segments.

5. The termination structure according to claim 1, comprising at least a semi-isolated structure terminating the regular line-space pattern at least partially.

6. The termination structure according to claim 1, wherein the pattern comprises at least one of the group of a wordline structure, a bitline structure, a contact structure, an isolating structure, an active area structure and a trench structure.

7. The termination structure according to claim 1, wherein multiple extension elements are positioned in a periodic pattern along the first line-shaped element.

8. The termination structure according to claim 1, wherein multiple extension elements are positioned only on one side of the first line-shaped element.

9. The termination structure according to claim 1, wherein multiple extension elements are positioned on both sides of the first line-shaped element.

10. The termination structure according to claim 9, wherein multiple extension elements are positioned alternating on both sides of the first line-shaped element.

11. The termination structure according to claim 1, wherein the at least one extension element has a shape of at least one of the group of rectangular, semicircular, triangular, t-shaped and polygonal.

12. The termination structure according to claim 1, wherein the at least one extension element is adjacent to a second line-shaped element positioned in parallel to the first line-shaped element.

13. The termination structure according to claim 1, wherein the at least one extension element at least partially is adjacent to a second line-shaped element on the side facing away from the first line-shaped element.

14. The termination structure according to claim 1, wherein the at least one extension element is aligned with at least one sub resolution assist feature.

15. The termination structure according to claim 1, wherein the at least one extension element is positioned on the side of the first line-shaped element facing away from the pattern, especially a regular pattern.

16. The termination structure according to claim 1, wherein the at least one extension element is positioned so that it is geometrically aligned with at least one part of the regular pattern, especially a trench structure.

17. The termination structure according to claim 1, wherein the at least one extension element adjacent to the at least one line-shaped element increases the width of the line-shaped element by a factor in the range of 1.05 to 3.

18. The termination structure for a pattern, especially an at least partially regular spaced pattern in the manufacturing of semiconductor devices, especially DRAM-chips, wherein the termination structure comprises at least a first line-shaped element and at least one extension means adjacent to the first line-shaped element partially increasing the width of the first line-shaped element.

19. The termination structure according to claim 18, wherein the termination structure is positioned on at least one of the group of substrate, silicon wafer and lithography mask.

20. The termination structure according to claim 18, wherein in longest axis of the first line-shaped element is at least three times higher than the broadest width of the first line-shaped element.

21. The termination structure according to claim 20, wherein the fist line-shaped element comprises at least two segments.

22. The termination structure according to claim 18, comprising at least a semi-isolated structure terminating the regular line-space pattern at least partially.

23. The termination structure according to claim 18, wherein the pattern comprises at least one of the group of a wordline structure, a bitline structure, a contact structure, an isolating structure, an active area structure and a trench structure.

24. The termination structure according to claim 18, wherein multiple extension means are positioned in a periodic pattern along the first line-shaped element.

25. The termination structure according to claim 18, wherein multiple extension means are positioned on one side of the first line-shaped element.

26. The termination structure according to claim 18, wherein multiple extension means are positioned on both sides of the first line-shaped element.

27. The termination structure according to claim 18, wherein multiple extension means are positioned alternating on both sides of the first line-shaped element.

28. The termination structure according to claim 18, wherein at least one extension means has a rectangular shape.

29. The termination structure according to claim 18, wherein the at least one extension means contacts a second line-shaped element positioned in parallel to the first line-shaped element.

30. The termination structure according to claim 18, wherein the at least one extension means contacts at least partially a second line-shaped element on the side facing away from the first line-shaped element.

31. The termination structure according to claim 18, wherein the at least one extension means is aligned with at least one subresolution assist feature.

32. The termination structure according to claim 18, wherein the at least one extension means is positioned on the side of the first line-shaped element facing away from a pattern

33. The termination structure according to claim 18, wherein the at least one extension means is positioned so that it is geometrically aligned with at least one part of the pattern, especially a trench structure.

34. The termination structure according to claim 18, wherein the at least one extension means adjacent to the at least one line-shaped element increases the width of the line-shaped element by a factor in the range of 1.05 to 3.

35. A mask for manufacturing a termination structure for pattern, especially an at least partially regular spaced pattern on a substrate used in the manufacturing of semiconductor devices, especially DRAM-chips, wherein the termination structure comprises at least a first line-shaped element and at least one extension element adjacent to the first line-shaped element partially increasing the width of the first line-shaped element.

36. The lithography process in which a mask according to claim 35 is used.

37. The lithography process according to claim 36, wherein at least one subresolution structure is used to optically stabilize the at least one extension element.

38. The semiconductor device, especially one of the groups of DRAM-chip and microprocessor, with at least one termination structure according to claim 1.
